(19) United States
(12) Patent Application Publication
(10) Pub. No.: US 2016/0025999 A1
(43) Pub. Date: Jan. 28, 2016

(54) FOLDABLE FRAME OF EYEGLASSES

(71) Applicant: PROHERO GROUP CO., LTD., Tainan City (TW)

(72) Inventor: PEN-WEI CHEN, TAINAN CITY (TW)

(21) Appl. No.: 14/340,667

(22) Filed: Jul. 25, 2014

(51) Int. Cl. G02C 5/00

(52) U.S. Cl. CPC G02C 5/006

(57) ABSTRACT

A foldable frame of eyeglasses includes two fronts pivotably connected two ends of a bridge. Each front has an installation portion so as to accommodate a lens therein. A first plate extends from the top edge of each front and toward the rear side of the front. Two temples are respectively and pivotably connected to the two fronts and each temple includes two sections which are pivotably connected to each other. A second plate and a shade respectively extending from the top edge and the bottom edge of the section that is pivotably connected to the front corresponding thereto. The second plate extends inward and toward the other temple and the lower edge of the shade reaches the lower edge of the front corresponding thereto. The foldable frame is mounted to the existed frame and protects the user's eyes from wind, dust and ultra-violet rays.

### BACKGROUND OF THE INVENTION

1. Fields of the Invention

The present invention relates to a foldable frame of eyeglasses, and more particularly, to a foldable frame of eyeglasses and the foldable frame being mounted to other eyeglasses.

2. Descriptions of Related Art

There are different types of eyeglasses such as sunglasses, sport glasses, and correction glasses, and these glasses become personal characters in many ways. In order to obtain different fashion styles and other purposes, people prepare many pairs of eyeglasses to be matched with the fashions of clothes and even the make-ups. Each pair glasses require a box for storage when not in use and also for protecting the lens of the glasses.

The conventional frame of a pair of glasses includes fronts with which the lenses are engaged. Two temples are pivotably connected to the two fronts respectively and the temples are pivoted to be parallel to the fronts when being stored in the box. In order to use the different glasses for different uses, the user has to carry multiple boxes and glasses and this requires a lot of space. It is inconvenient for the user to carry multiple pairs of eyeglasses and the boxes.

Besides, the sunglasses, goggles and safety goggles generally do not have correction lenses, so that the users have difficulties to use these types of glasses with proper correction features. In order to improve the shortcoming, some manufacturers develop attachable lenses which have features for protection the user's eyes from dust and ultra-violet rays, and can be easily snapped to the frame and overlapped to the lenses of the frame. Therefore, the user can use the correction lenses to be cooperated with the attachable lenses so as to meet the needs of the users. However, these attachable lenses are expensive and easily separated from the frame of the eyeglasses.

The present invention intends to provide a foldable frame which can be easily cooperated the existed frame of the user to eliminate the shortcomings mentioned above.

### SUMMARY OF THE INVENTION

The present invention relates to a foldable frame of eyeglasses and comprises two fronts pivotably connected to two ends of a bridge. Each front has an installation portion so as to accommodate a lens therein. A first plate extends from the top edge of each front and toward the rear side of the front. Two temples are respectively and pivotably connected to the two fronts and each temple includes two sections which are pivotably connected to each other. A second plate and a shade respectively extending from the top edge and the bottom edge of the section that is pivotably connected to the front corresponding thereto. The second plate extends inward and toward the other temple and the lower edge of the shade reaches the lower edge of the front corresponding thereto.

The primary object of the present invention is to provide a foldable frame which is able to be directly mounted to the existed frame by engaging the first and second plates with the temples of the existed eyeglasses that have correction features.

Another object of the present invention is to provide a foldable frame wherein the temples are folded to each other, and the two fronts are pivoted relative to the bridge so as to reduce the required storage space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the foldable frame of the present invention;

FIG. 2 is a top view of the foldable frame of the present invention;

FIG. 3 shows that one section of each of the temples is pivoted;

FIG. 4 shows that the other one section of each of the temples is pivoted, and

FIG. 5 shows that the two fronts and the temples are folded.

### DETAILED DESCRIPTION OF THE PREFERRED EMBODIMENT

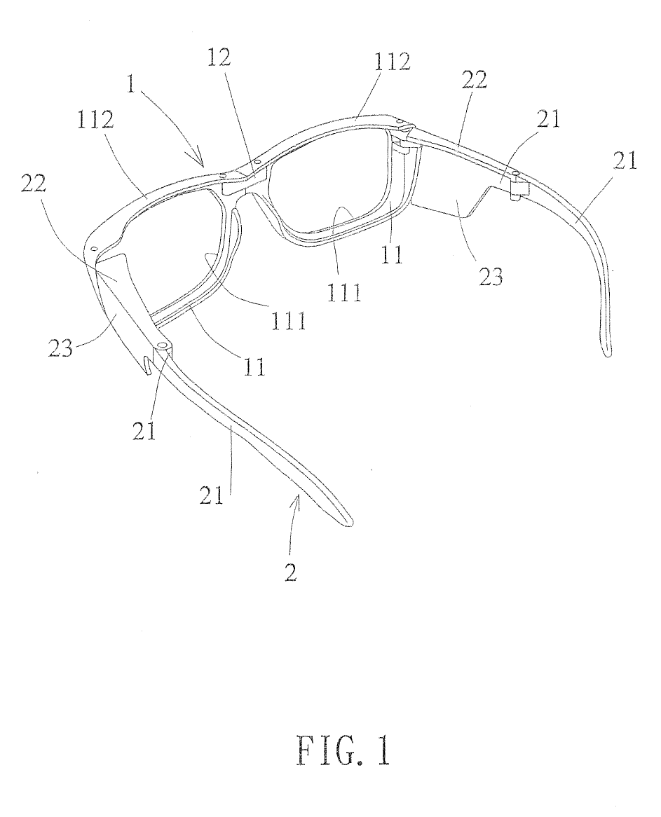

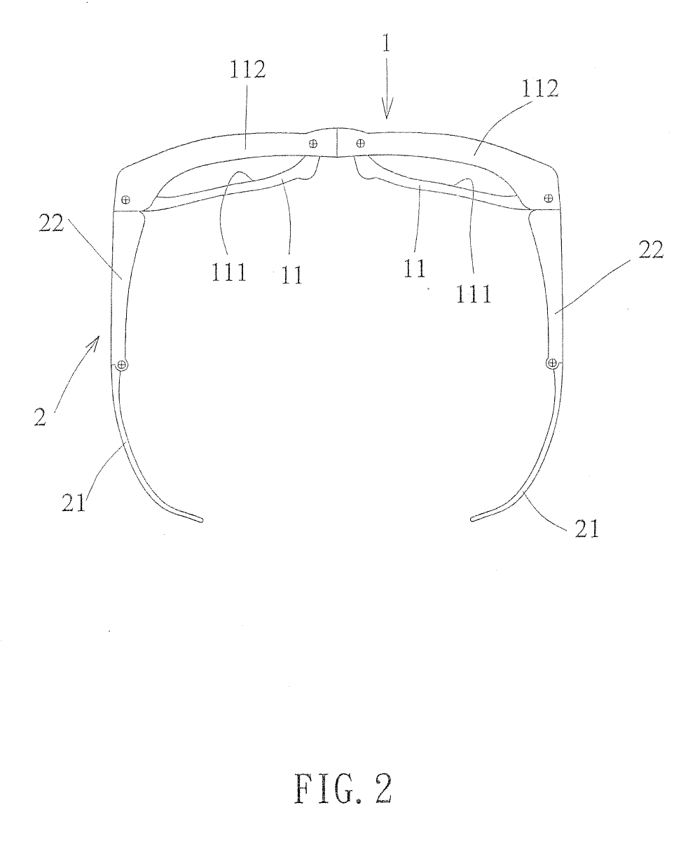

Referring to FIGS. 1 to 2, a foldable frame 1 of the present invention comprises two fronts 11 which are pivotably connected to two ends of a bridge 12. Each front 11 has an installation portion 111 defined in an inside thereof so as to accommodate a lens therein. Each front 11 has a front side and a rear side, and a first plate 112 extends from the top edge of each front 11 and toward the rear side of the front 11.

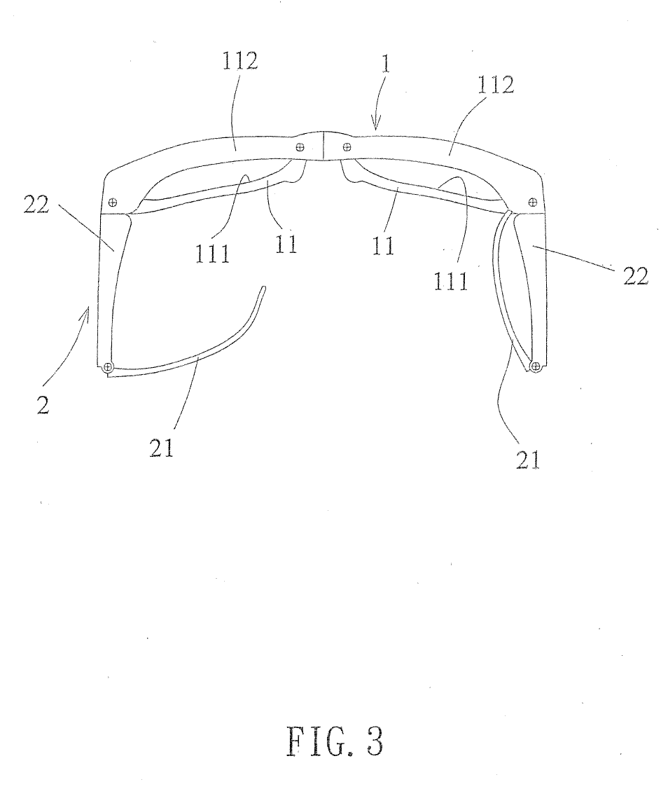

Two temples 2 are respectively and pivotably connected to the two fronts 11 and each temple 2 comprises two sections 21 which are pivotably connected to each other. In other words, each of the two temples 2 can be folded at the mediate portion thereof as shown in FIG. 3. A second plate 22 extends from the top edge of the section 21 that is pivotably connected to the front 11 corresponding thereto. The second plate 22 extends inward and toward the other temple 2 when the two temples 2 are expanded. A shade 23 extends from the bottom edge of the section 21 that is pivotably connected to the front 11 corresponding thereto. The shade 23 extends substantially perpendicular to the front 11 when in use. The lower edge of the shade 23 reaches the lower edge of the front 11 corresponding thereto.

When in use, the user pivots the two fronts 11 relative to the bridge 12 so that the two fronts 11 are positioned at the two ends of the bridge 12. The two temples 2 are then pivoted and expanded by pivoting the sections 21 that are directly connected to the fronts 11, and the other section 21 of each temple 2 is then pivoted so that the two sections 21 of each temple 2 are positioned at the pivotal connection portion. The frame 1 is then able to be worn. The shades 23 extend to the bottom edges of the fronts 11 to cover the gap between the temples 2 and the fronts 11 such that dust and wind cannot affect the user's eyes. In some cases, the shades 23 protects the user's eyes from being injured by foreign objects such as wood or metal chips or particles when the frame 1 is used as a safety goggles.

When the frame 1 is cooperated with the existed eyeglasses having correction features such as correction eyeglasses, the frame 1 is mounted to the existed frame of the eyeglasses by clamping the first and second plates 112, 22 to the temples of the existed eyeglasses. By this way, the frame 1 is mounted to the existed eyeglasses and the shades 23 protect the user's eyes while the user still have good vision through the correction lenses of the existed eyeglasses.

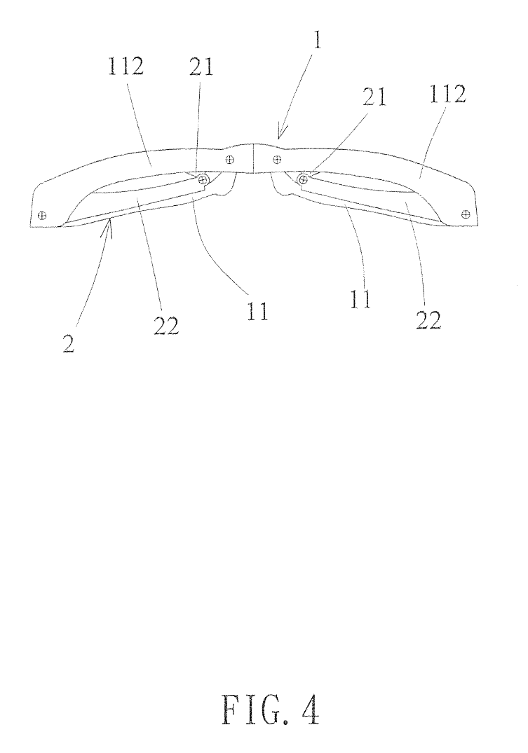

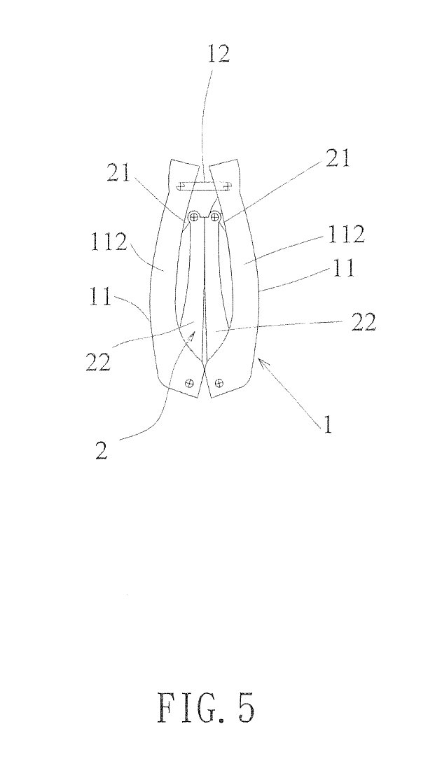

When the frame 1 of the present invention is not in use, as shown in FIGS. 3 and 4, the two sections 21 of each temple 2 are pivoted inward until the folded sections 21 are parallel to the front 11 corresponding thereto. The two fronts 11 are then pivoted relative to the bridge 12 as shown in FIG. 5, such that the frame 1 is folded to be a compact size which is easily carried and stored.

The frame 1 of the present invention provides first and second plates 112, 22 on each temple 2 so that the frame 1 can be mounted to an existed eyeglasses securely. The first and second plates 112, 22 also cover up gaps between the temples 2 and the fronts 11 and the user's face.

The two temples 2 and the two fronts 11 of the frame 1 are easily folded to make the folded frame 1 of the present invention be compact and easily stored in a pocket or a bag.

The shades 23 protect the user's eyes from dust, wind and foreign chips and particles. The frame 1 can be used as a safety goggles while the existed eyeglasses are still used.

While we have shown and described the embodiment in accordance with the present invention, it should be clear to those skilled in the art that further embodiments may be made without departing from the scope of the present invention.

What is claimed is:

1. A foldable frame of eyeglasses, comprising:
two fronts pivotably connected to two ends of a bridge, each front having an installation portion for being accommodating a lens therein, each front having a front side and a rear side, a first plate extending from a top edge of each front and toward the rear side of the front, and
two temples respectively and pivotably connected to the two fronts and each temple comprising two sections which are pivotably connected to each other, a second plate extending from a top edge of the section that is pivotably connected to the front corresponding thereto, the second plate extending inward and toward the other temple, a shade extending from a bottom edge of the section that is pivotably connected to the front corresponding thereto, a lower edge of the shade reaching a lower edge of the front corresponding thereto.
